(19) United States
(12) Patent Application Publication
(10) Pub. No.: US 2011/0139023 A1
(43) Pub. Date: Jun. 16, 2011

(54) PRINTING UNIT WITH TWO SPACING DEVICES AND CORRESPONDING USE

(75) Inventors: Dominique Malkic, Verneuil En Halatte (FR); Timothee Laloy, Nogent Sur Oise (FR)

(73) Assignee: Goss International Montataire S.A., Montataire (FR)

(21) Appl. No.: 12/737,000

(22) PCT Filed: May 22, 2009
(86) PCT No.: PCT/FR2009/050950

§ 371 Date: Feb. 23, 2011

(30) Foreign Application Priority Data
May 28, 2008 (FR) 08 53476

(51) Int. Cl. B41F 13/24

(52) U.S. Cl. 101/248

(57) ABSTRACT

A printing unit including: a frame; a first print station (6) having a first blanket cylinder (10) and a first plate cylinder (12); an impression cylinder (14); and a first spacer device (100) designed to move the cylinders relative to each other between a printing configuration in which the plate cylinder (12) is in contact with the associated blanket cylinder (10) and a non-printing configuration in which the plate cylinder (12) is moved away from the blanket cylinder (10) and the blanket cylinder (10) is moved away from the impression cylinder (14). The printing unit also includes a second spacer device (200) designed to regulate the distance between the cylindrical surfaces of the first blanket cylinder (10) and the impression cylinder (14), said second spacer device (200) including means for moving the impression cylinder (14) radially relative to the first blanket cylinder (10) and relative to the frame.

The present invention concerns a printing unit comprising:

a frame;

a first print set having a first blanket cylinder and a first plate cylinder;

an impression cylinder; and

a first spacing device designed to move the cylinders relative to each other between a printing configuration in which the plate cylinder is in contact with the associated blanket cylinder, and a non-printing configuration in which the plate cylinder is moved away from the first blanket cylinder and the first blanket cylinder is moved away from the impression cylinder.

### BACKGROUND

The invention particularly concerns offset rotary presses.

The spacing device of such a printing unit allows the impression cylinders to be moved away when a paper break occurs. Indeed, during the use of the printing unit, the strip of paper unwound from the reel may tear. Even if the cylinders of the printing unit are stopped immediately after such a tear, inevitably a certain amount of torn paper will wind around the cylinders after the unforeseen breakage. By actuating the spacing device, it is the possible to move the cylinders away from each other to move them to the non-printing configuration and thus remove the paper blocked around the cylinders. Once the broken paper is removed, the spacing device is then reactivated in the opposite direction to move the cylinders into the printing configuration. The printing operation can then resume.

### SUMMARY OF THE INVENTION

An object of the present invention is to improve the printing quality of this type of printing unit.

The present invention provides a printing unit of the aforementioned type, characterized in that the printing unit also comprises a second spacing device designed to regulate the distance between the cylindrical surfaces of the first blanket cylinder and the impression cylinder, the second spacing device comprising means for moving the impression cylinder radially relative to the first blanket cylinder and relative to the frame.

By providing a second spacing device at the printing unit, said second spacing device making it possible to adjust the distance between the cylindrical surfaces of the first blanket cylinder and the impression cylinder, it becomes possible to adapt the printing unit as a function of the thickness or grammage of the paper used for the printing. Indeed, the optimal distance between the cylindrical surfaces of the first blanket cylinder and the impression cylinder is higher for a thick paper than for a thin paper. With the second spacing device according to the invention, it is then possible to take these differences in the paper thickness into account and thus to keep a good printing quality independently of the type of paper used.

According to specific embodiments of the invention, the printing unit comprises one or several of the following features:

the printing unit comprises a second print set comprising a second plate cylinder and a second blanket cylinder, the impression cylinder is the second blanket cylinder, and in that, in the printing configuration, the second plate cylinder is in contact with the second blanket cylinder, and in the non-printing configuration, the second plate cylinder is moved away from the second blanket cylinder;

the first print set is an upper print set and the second print set is a lower print set, the first plate cylinder being an upper plate cylinder and the first blanket cylinder being an upper blanket cylinder, the second blanket cylinder being a lower blanket cylinder and the second plate cylinder being a lower plate cylinder;

the first spacing device is designed to move the first and second plate cylinders and the first blanket cylinder between the printing configuration and the non-printing configuration, and the second blanket cylinder remains immobile during that movement;

the first spacing device includes eccentric bearings;

the second spacing device is a tripping/off center moving device and comprises:

two eccentric bearings housed in the frame, each eccentric bearing receiving one end of the impression cylinder, and

adjusting means designed to adjust the angular position of each eccentric bearing in relation to the frame;

the second spacing device comprises transmission means designed to transmit an adjustment movement, applied by the adjusting means on one of the bearings situated on one side of the frame, to the other bearing situated on another side of the frame;

the first spacing device comprises a shaft extending between two posts of the frame, and the transmission means comprises a tube surrounding said shaft;

the second spacing device comprises return means designed to move the second plate cylinder synchronously with the second blanket cylinder when the distance is adjusted, such that the second plate cylinder maintains contact with the second blanket cylinder in the printing configuration;

the return means comprises at least part of the first spacing device;

the second spacing device comprises a first collar fastened to the eccentric bearing and the return means comprises a member for returning a movement of this first collar to said portion of the first spacing device;

the first spacing device comprises a second collar associated with the second plate cylinder, and the return means comprises this second collar, the first collar being connected to the second collar via the return member;

the return member defines a first center of rotation around which it turns exclusively when the first spacing device is actuated and a second center of rotation, separate from the first center of rotation, around which it turns exclusively when the second spacing device is adjusted;

the return element is connected to the second collar by a connecting rod, and the return member is connected to the first collar by an extension of the first collar;

the return member is connected to the first collar by a connecting rod, and the return member is connected to the second collar by an extension of the second collar;

the return member is a return triangle that is either made up of three apices connected by straight segments, or made up of two arms connected by a bend;

the second plate cylinder is associated with an eccentric bearing with four rings, a first ring of said bearing being part of the first spacing device, a second ring of said bearing being part of the second spacing device;

the adjusting means comprises:

a pivoting flange connected to the eccentric bearing;

a tapping connected to the pivoting flange;

a threaded rod engaged with the tapping; and

means for driving the rotation of the threaded rod; actuating this drive means causing the eccentric bearing to rotate; and

the second spacing device makes it possible to adjust the distance to a value exclusively between 0 and 0.3 mm.

The invention also concerns a method for using a printing unit of the aforementioned type, comprising a step for adjusting the distance between the first blanket cylinder and the impression cylinder as a function of the thickness of the paper by the second spacing device.

### BRIEF DESCRIPTION OF THE DRAWINGS

The invention will be better understood upon reading the description that follows, provided solely as an example, and done in reference to the appended drawings, in which:

FIG. 1 is a first perspective view of an embodiment of a printing unit according to the invention, certain elements having been omitted;

FIG. 2 is a second perspective view of the printing unit of FIG. 1, certain elements having been omitted;

FIG. 3 is a side view of one of the two sets of collars of the spacing system of the printing unit of FIGS. 1 and 2;

FIG. 4 is a side view of the adjusting means of the second spacing device of the printing unit of FIGS. 1 and 2;

FIG. 5 is a top view of the adjusting means of FIG. 4;

FIG. 6 is a transverse cross-sectional view through the adjusting means of FIG. 4;

FIG. 7 is a perspective view of a second set of collars of the spacing system of the printing unit of FIGS. 1 and 2;

FIGS. 8 to 11 illustrate the operation of the two spacing devices of the printing unit of FIGS. 1 and 2; and

FIGS. 12 to 14 show alternative embodiments of the second spacing device according to the invention.

### DETAILED DESCRIPTION

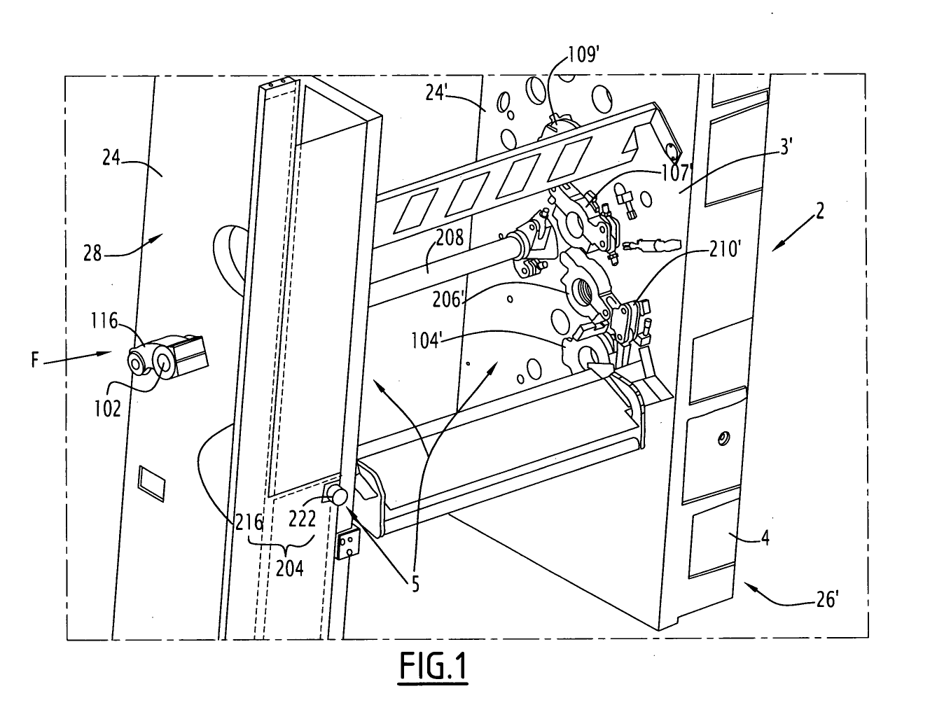

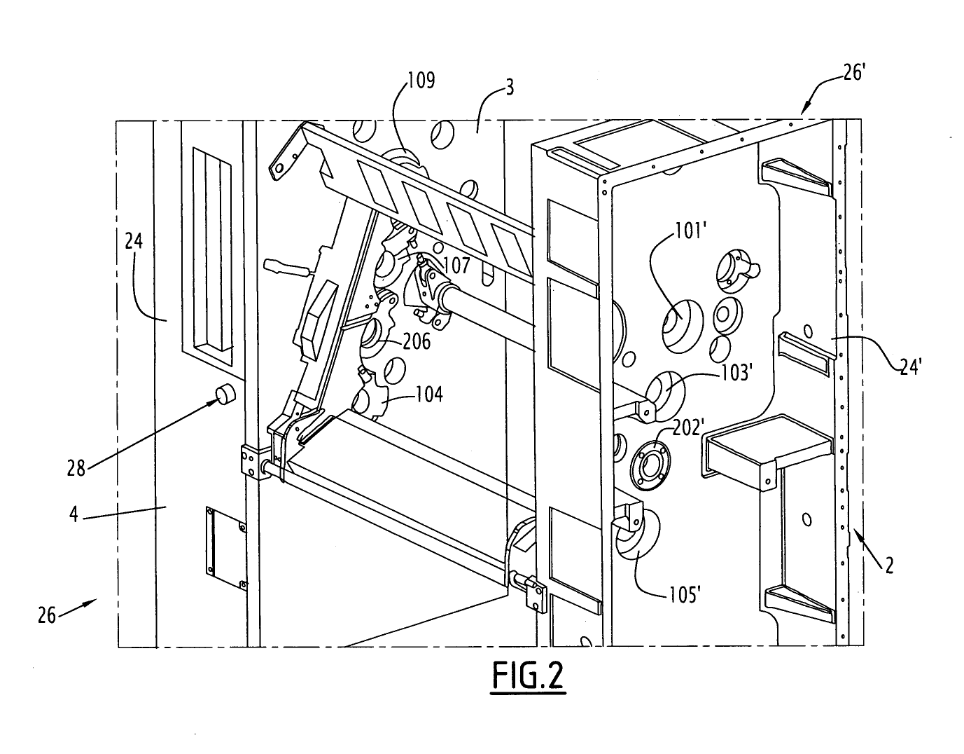

FIGS. 1 and 2 illustrate a printing unit 2 in which the upper and lower print sets, each comprising a blanket cylinder and a plate cylinder, have been omitted so as to be able to see the two spacing devices. The printing unit 2 comprises a frame 4, which supports the various mechanical elements of the printing unit 2. The frame 4 has two posts 24 and 24′, these two posts corresponding to the two lateral ends of the printing unit 2. The side 26 of the printing unit, where the post 24 is situated, is commonly called the “function side,” while the side 26′, where the post 24′ is located, is commonly called the “control side.” Hereinafter, for all of the elements of the printing unit 2 found on each side 26 and 26′ thereof, we will use a reference number followed by an apostrophe to designate the control side, whereas reference numbers without apostrophes will designate elements on the function side.

It will be noted that FIGS. 1 and 2 correspond to diagonal views, FIG. 1 making it possible to see the inner face 3′ of the post 24′, whereas FIG. 2 makes it possible to see the inner face 3 of the post 24 of the frame 4.

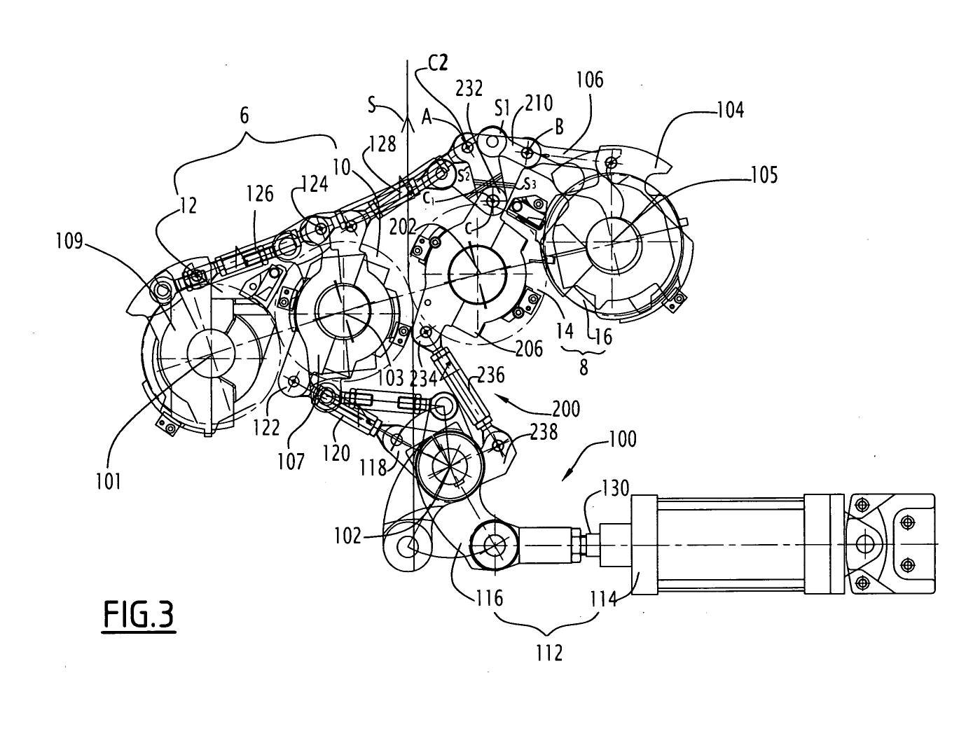

In reference to FIG. 3, the printing unit 2 comprises an upper printing set 6, formed by a first plate cylinder or upper plate cylinder 12 and a first blanket cylinder or upper blanket cylinder 10, as well as a lower printing set 8, formed by a second plate cylinder or lower plate cylinder 16 and a second blanket cylinder or lower blanket cylinder 14. The lower blanket cylinder 14 can also be an impression cylinder 14 for the upper blanket cylinder 10.

The printing unit 2 has the particularity of having two spacing devices 100 and 200 that together form a spacing system 5 (cf. FIG. 1).

It will be noted that the elements belonging to the first spacing device 100 are designated using reference numbers between 101 and 199, while the elements of the second spacing device 200 are designated by reference numbers between 201 and 299.

The spacing system 5 is preferably a tripping/off center moving system, as illustrated in the figures, with a first off center moving device 100 and a second off center moving device 200. The off center moving system 5 comprises two sets of four eccentric bearings 101, 103, 202, 105 and 101′, 103′, 202′ and 105′, two sets of four collars 104, 206, 107, 109 and 104′, 206′, 107′ and 109′, a dual eccentric shaft 102, 208, a means 112 for actuating the first off center moving device 100, and means 204 for adjusting the second off center moving device 200.

The first set of four eccentric bearings 101, 103, 202 and 105 is housed vertically inside the post 24 of the frame 4 (cf. FIGS. 1 and 3). The second set of eccentric bearings 101′, 103′, 202′ and 105′ is located opposite the first set in the other post 24′ of the frame 4 (cf. FIG. 2). These eight bearings receive the four drive shafts of the four cylinders of the printing unit 2.

More specifically, the bearings 101, 101′ receive the drive shaft of the upper plate cylinder 12, the bearings 103, 103′ receive the drive shaft of the upper blanket cylinder 10, the bearings 202 and 202′ receive the drive shaft of the lower blanket cylinder 14 and the bearings 105 and 105′ receive the drive shaft of the lower plate cylinder 16.

The set of collars 104, 206, 107 and 109 is associated with the set of bearings 101, 103, 202 and 105, while the set of collars 104′, 206′, 107′ and 109′ is associated with the set of bearings 101′, 103′, 202′ and 105′. More specifically, the collar 109 (109′) is secured to the bearing 101 (101′). The collar 107 (107′) is secured to the bearing 103 (103′), the collar 206 (206′) is secured to the bearing 202 (202′) and the collar 104 (104′) is secured to the bearing 105 (105′) (cf. FIG. 3).

Each eccentric bearing is a three-ring bearing, with an inner ring, a middle ring and an outer ring. The inner ring receives the shaft of the associated cylinder. Each collar is secured to the middle ring of the associated eccentric bearing.

The inner ring and the middle ring are connected by bearing bodies and thus together form a bearing for the rotation of the associated cylinder during printing. The middle ring and the outer ring together form a smooth bearing, the outer ring being fastened to the frame 24. Thus, the middle ring is able to rotate by sliding in relation to the outer ring and therefore in relation to the frame 24.

The axis of rotation in relation to the frame of the smooth bearing formed by the middle ring and the outer ring is different from the axis of rotation in relation to the frame of the bearing formed by the middle ring and the inner ring.

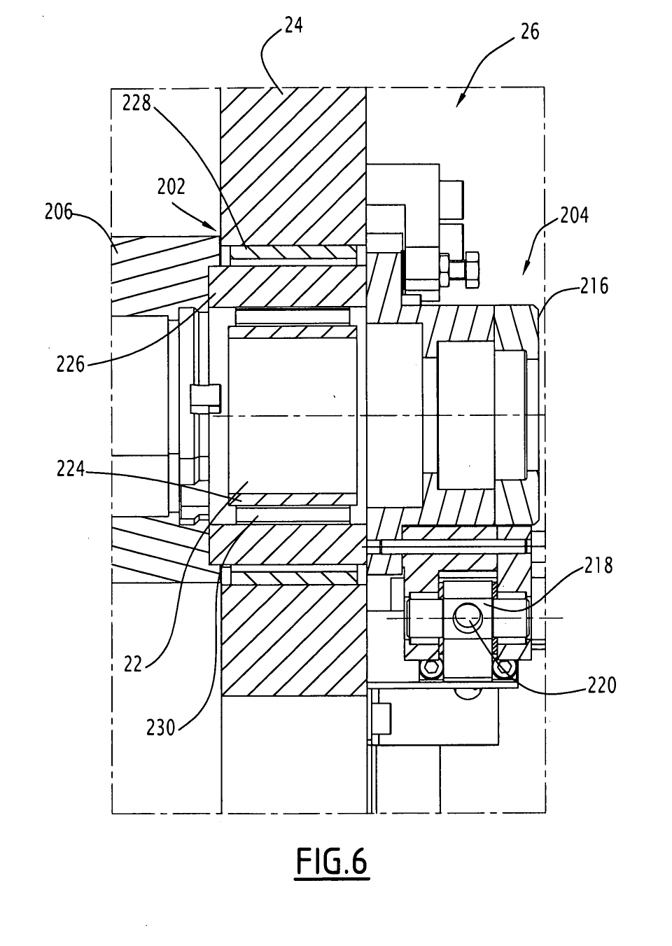

The dual eccenter shaft 102, 208 comprises a central shaft 102 that is surrounded by a tube 208 (cf. FIG. 7). This dual shaft ensures the connection between the two sets of collars on one side 26 and the other side 26′ of the printing unit 2 (cf. FIG. 1). The means 112 for actuating the first off center moving device 100 is secured to the shaft 102 of the dual off center moving shaft (cf. FIG. 3), whereas the means 204 for adjusting the second off center moving device 200 is secured to the eccentric bearing 202 (cf. FIG. 6).

FIG. 3 shows the structure of the first off center moving device 100. FIG. 3 is a side view of the printing unit 2 along arrow F of FIG. 1, the post 24 not being shown. FIG. 3 therefore illustrates the side 26 or “function side” of the off center moving system 5. In FIG. 3, one can see an arrow S that indicates the trajectory of the strip of paper through the printing unit 2 during printing.

The first off center moving device 100 comprises a jack 114 that is connected to a lever 116, the jack 114 and the lever 116 together forming the actuating means 112. The lever 116 is fastened on the shaft 102 of the dual off center moving shaft. The shaft 102 is provided with two levers 118, 118′. The distant end of the shaft 102 of each of these levers 118, 118′ forms a first fork that receives the end of a connecting rod 120, 120′, pivotably mounted on said first fork. The other end of the connecting rod 120, 120′ is connected to the collar 107, 107′ of the upper blanket cylinder 10. The connection between the end of the rod 120, 120′ and the collar 107, 107′ is ensured by a second fork 122, 122′ formed on the collar 107, 107′. On its side substantially opposite the second fork 122, 122′, the collar 107, 107′ has a third fork 124, 124′ that receives the ends of two connecting rods 126, 126′ and 128, 128′. The rods 126, 126′ and 128, 128′ ensure the connection to the collar 109, 109′ of the upper plate cylinder 12 and to the collar 104, 104′ of the lower plate cylinder 16, respectively. The collars 104, 107 and 109 are fastened to the bearings 105, 103 and 101, respectively.

The off center moving device 100 is completed, on the other side of the printing unit 2, i.e. on the control side 26′, by a second set of three collars 104′, 107′ and 109′ respectively fastened to eccentric bearings 105′, 103′ and 101′, this second set of collars being identical to the first function side 26 just described. The connection between these two sets of collars is ensured by the transverse shaft 102 that extends from the function side 26 to the control side 26′ (cf. FIG. 7).

The operation of the off center moving device 100 will now be described in reference to FIG. 3. When an unexpected paper break is detected, the cylinders of the printing unit 2 are stopped. The cylinders are brought into a non-printing configuration in which the first plate cylinder 12 is moved away from the first blanket cylinder 10 and the first blanket cylinder 10 is moved away from the impression cylinder 14.

This operation moving the cylinders away is triggered by the activation of the jack 114. The connecting rod 130 of the jack 114 then moves to cause the lever 116 to pivot, and with it the shaft 102. The levers 118, 118′ retrace this pivoting and drive the connecting rods 120, 120′ with them. The connecting rods 120, 120′ thus make the collars 107, 107′ move. This pivoting movement is transmitted by the connecting rods 126, 126′ and 128, 128′ to the collars 104, 104′ and 109, 109′. The transmission of the movement to the collars 104, 104′ is done via return triangles 210, 210′. During that transmission, the return triangles 210, 210′ rotate exclusively around a first center of rotation C1. The six collars 104, 104′, 107, 107′ and 109, 109′ being fastened to the eccentric bearings 105, 105′, 103, 103′ and 101, 101′, a rotation of the eccentric bearings is thus obtained, and more particularly of the middle rings of those bearings around their axis of rotation, which causes a separating movement of the lower plate cylinder 16, the upper blanket cylinder 10, and the upper plate cylinder 12.

With the cylinders thus moved away, it is then easy to remove the paper wound around the cylinders due to the paper break. The collars 206, 206′ and their associated lower blanket cylinder remain immobile during activation of the first off center moving device 100. Indeed, the off center moving device 100 only moves the lower plate cylinder 16, the upper blanket cylinder 10 and the upper plate cylinder 12.

Once the broken paper has been removed from the cylinders, it is possible to reactive the jack 114, which will perform an inverse translation movement to bring the cylinders into their printing configuration.

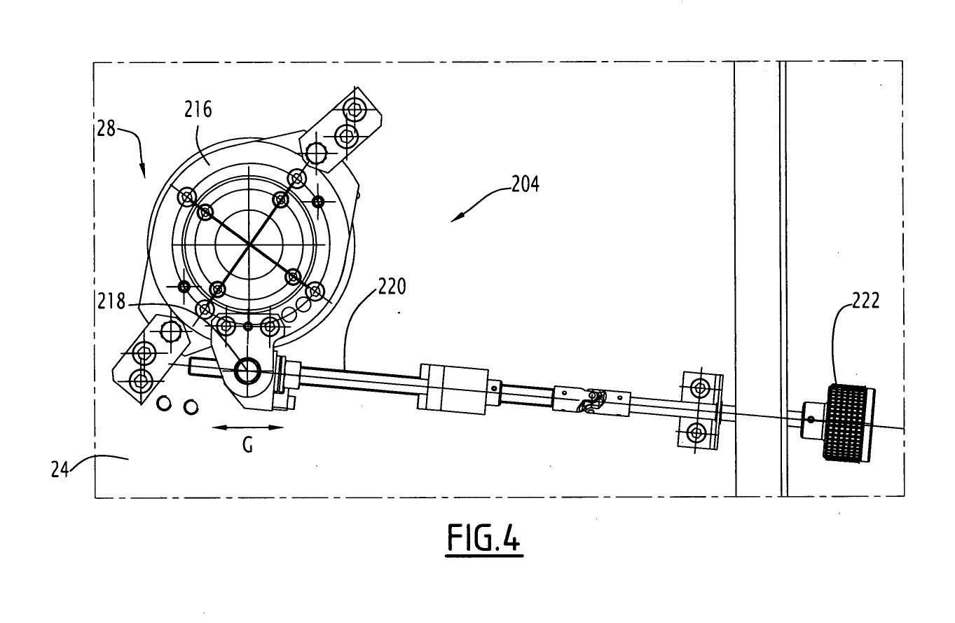

The preferred embodiment of the second off center moving device 200 according to the invention will now be described in reference to FIGS. 4 to 7.

The second off center moving device 200 primarily comprises the adjusting means 204 shown in FIG. 4, two eccentric bearings 202, 202′ (cf. FIG. 6) on either side of the printing unit 2, these eccentric bearings receiving the ends of the drive shaft of the lower blanket cylinder 14, and means ensuring the connection between, on one hand, the two eccentric bearings 202, 202′ and, on the other hand, between the second off center moving device 200 and the first off center moving device 100.

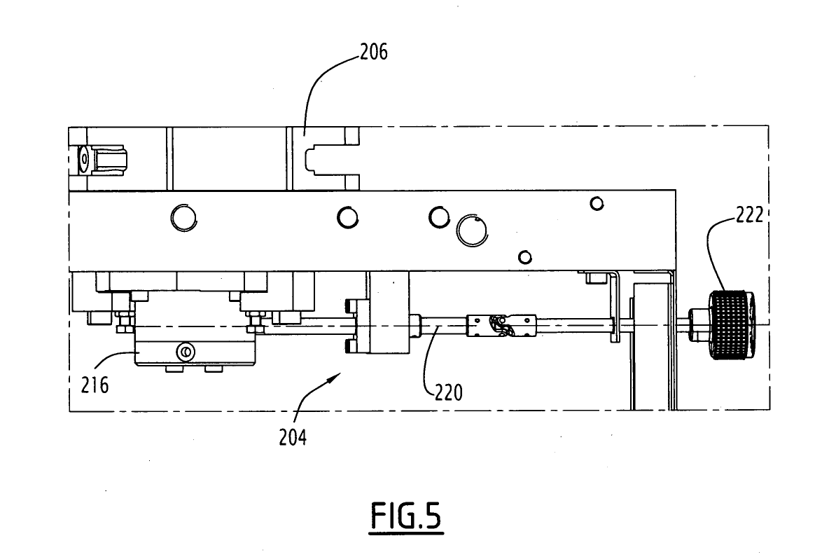

The adjusting means 204 is shown in reference to FIG. 4. This means is arranged on the outer face 28 of the post 24 of the frame 4 (cf. FIG. 1). A rotary adjustment button 222 is mounted on a threaded universal joint shaft 220. Mounted at the end of said threaded shaft 220 is a tapping nut 218 fastened on a pivoting flange 216. The pivoting flange 216 is connected to the eccentric bearing 202, which in FIG. 4 is hidden behind the flange 216 and is formed in the post 24 of the frame 4. As shown in FIG. 5, the eccentric bearing 202 is connected, by its opposite side, to the collar 206 of the lower blanket cylinder 14.

FIG. 6 is a transverse cross-section through the post 24 of the frame 4 showing, in detail, the connections between the flange 216, the eccentric bearing 202 and the collar 206. In reference to FIG. 6, the eccentric bearing 202 is a three-ring bearing, with an inner ring 224, a middle ring 226, and an outer ring 228. The inner ring 224 is fastened to one end 22 of the drive shaft of the lower blanket cylinder 14. The end 22 of the drive shaft is able to rotate, together with the inner ring 224, inside the eccentric bearing 202 in relation to rolling bodies such as needle rollers 230.

The middle ring 226 is fastened on one side to the flange 216 and on the other side to the collar 206. The inner ring 224 is slightly off-center in relation to the middle ring 226, by about 1 mm. The middle ring 226 and the outer ring 228 together form a smooth bearing, i.e. the middle ring 226 is able to perform a rotation by sliding in relation to the outer ring 228, said outer ring 228 being fastened to the post 24 of the frame 4.

The structure of the eccentric bearings 202′, situated on the control side 26′ of the printing unit 2, is identical to the structure of the eccentric bearing 202 described above. The collar 206′ of the control side 26′ is fastened to the eccentric bearing 202′ in the same way as the collar 206 to the eccentric bearing 202. Of course, the adjusting means 204 are not reproduced on the control side 26′.

In reference to FIG. 3, the collar 206 has a substantially annular appearance, aside from two forks 232 and 234, one being substantially opposite the other. The fork 232 is secured to a return triangle 210 that ensures coupling with the first off center moving device 100. Indeed, the return triangle 210 is secured by the connecting rod 106 to the collar 104 and therefore to the eccentric bearing 105 of the first off center moving device 100. In other words, the second off center moving device 200 uses the elements 104, 105 and 106 of the first off center moving device 100. These elements are therefore part of both off center moving devices at once.

The return triangle 210 is made up of three apices A, B, C connected by straight segments S1, S2, S3. The fork 234 receives the end of one connecting rod 236, said connecting rod 236 being connected by its other end to a lever 238.

In reference to FIG. 7, the lever 238 is mounted on a tube 208 that is freely rotating around the shaft 102 of the first off center moving device 100. The lever 238 is mounted on the tube 208 at the end situated on the function side 26 of the printing unit 2. At the other end of the tube 208, there is a lever 238′ identical to the lever 238. The elements connected to the lever 238′, i.e. the connecting rod 236′, the collar 206′ and the eccentric bearing 202′ (not shown in FIG. 7) are identical reproductions of the corresponding elements of the function side 26 that ensure identical separation of the other end of the drive shaft from the lower blanket cylinder 14. Reproducing the same elements on the function side 26 and the control side 26′, connected by the tube 208, allows homogenous movement on either side of the lower blanket cylinder 14.

The operation of the second off center moving device 200 will now be described.

Imagine that an operator wishes to initiate printing with paper having a given thickness using the printing unit 2 according to the invention. Before starting the printing, the operator will adjust the distance between the lower blanket cylinder 14 and the upper blanket cylinder 10 as a function of the thickness of the paper to be printed owing to the second off center moving device 200 according to the invention.

To that end, the operator will rotate the rotary button 222 by a desired angle (cf. FIG. 4). This rotational movement is reproduced by the universal joint shaft 220. The shaft 220 being free only in rotation, but not in translation, its rotation will have the effect, via its threading engaged with the complementary tapping of the nut 218, of causing the nut 218 to move forward or backward, as indicated in FIG. 4 by double arrow G. This movement G translates to a pivoting of the flange 216 and therefore of the middle ring 226 and the collar 206 (cf. FIG. 6). This pivoting is transmitted via the tube 208 from the other side 26′ of the printing unit 2 and results in corresponding pivoting of the middle ring 226′ of the eccentric bearing 202′. The ends 22, 22′ of the drive shaft of the lower blanket cylinder 14 being housed slightly off-center inside the bearings 202, 202′, a pivoting of said bearings results in a slight radial movement of the lower blanket cylinder 14 in relation to the upper blanket cylinder 10. In this context, “radial movement” refers to a movement of the cylinder perpendicular to its longitudinal axis, i.e. a movement along the radius of the cylinder.

The connection kinematics of the return triangles 210, 210′ (cf. FIGS. 3 and 7) ensures continuous contact between the lower blanket cylinder 14 and the lower plate cylinder 16 during adjustment using the off center moving device 200. During said adjustment, the return triangles 210, 210′ rotate exclusively around a second center of rotation C2, separate from the first center of rotation C1 (cf. FIG. 3).

The adjustment using the off center moving device 200 must not result in a relative movement between the lower blanket cylinder 14 and the lower plate cylinder 16. Otherwise, the correct transmission of the image from the lower plate cylinder 16 to the lower blanket cylinder 14 during the printing to take place after the adjustment may be compromised. Owing to the return triangles 210, 210′, the pivoting movement of the collars 206, 206′ of the lower blanket cylinder 14 is reproduced by the collars 104, 104′ of the lower plate cylinder 16, such that the lower plate cylinder 16 follows the movement of the lower blanket cylinder 14 to cancel any relative movement between the two cylinders.

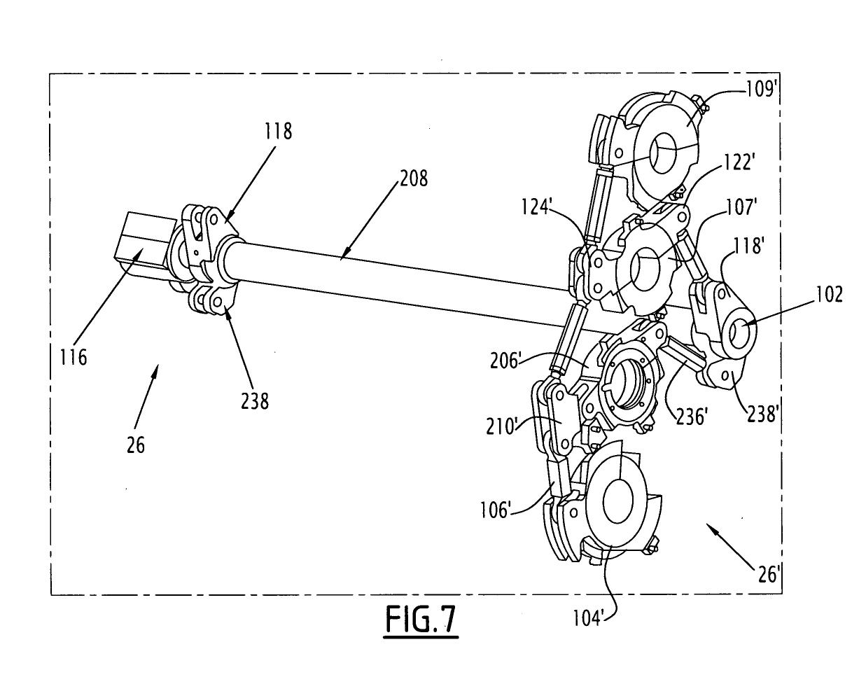

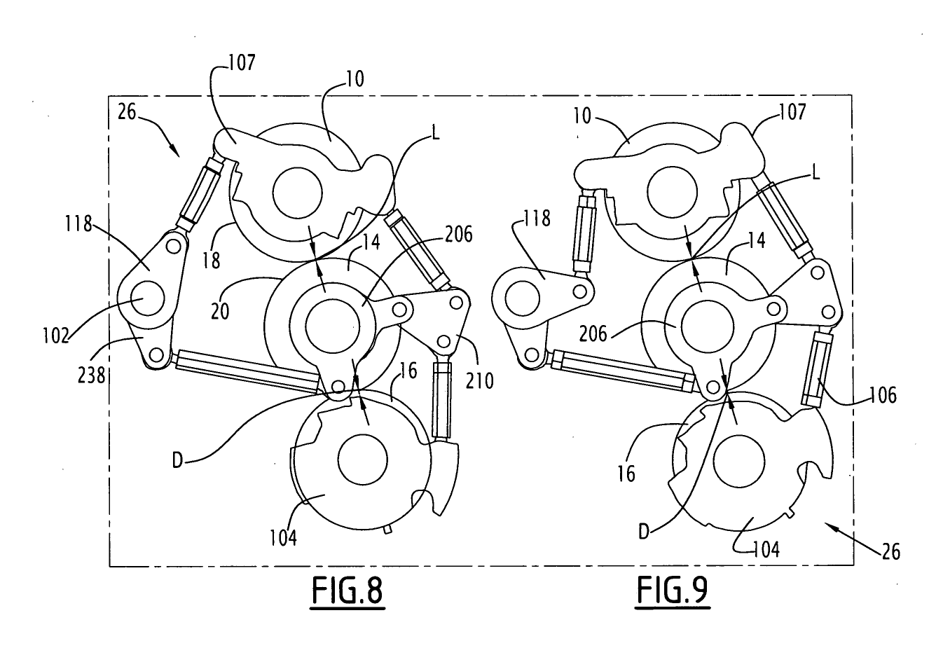

FIGS. 8 to 11 illustrate the behavior of the various elements of the two off center moving devices 100 and 200 during their actuation. FIGS. 8 to 11 illustrate the elements situated on the function side 26 of the printing unit 2. The corresponding elements situated on the other side 26′ have the same behavior as the elements of FIGS. 8 to 11.

The lower plate cylinder 16 with its collar 104, the lower blanket cylinder 14 with its collar 206, and the upper blanket cylinder 10 with its collar 107 are visible. The upper plate cylinder is not shown.

FIG. 8 shows the cylinders in their operational state, the first off center moving device 100 not having been activated and the second off center moving device 200 being in “min” adjustment move, where the distance L between the cylindrical surface 18 of the upper blanket cylinder 10 and the cylindrical surface 20 of the lower blanket cylinder 14 is substantially equal to 0 mm. It will be noted that the distance D between the cylindrical surface of the lower blanket cylinder 14 and the cylindrical surface of the lower plate cylinder 16 is also substantially equal to 0 mm.

In this context, “cylindrical surface” refers to the surface of revolution of the cylinder extending from one post of the frame 4 to the other.

The state shown in FIG. 9 corresponds to the state shown in FIG. 8, with the difference that the first off center moving device 100 has been activated. This activation causes pivoting of the lever 118 and consequently of the collars 107 and 104, which creates a separation of the cylinders 10 and 16 in relation to the cylinder 14. The cylinder 14 and its associated collar 206 have not moved, however. A value of L and D of about 1.5 mm results from this separation.

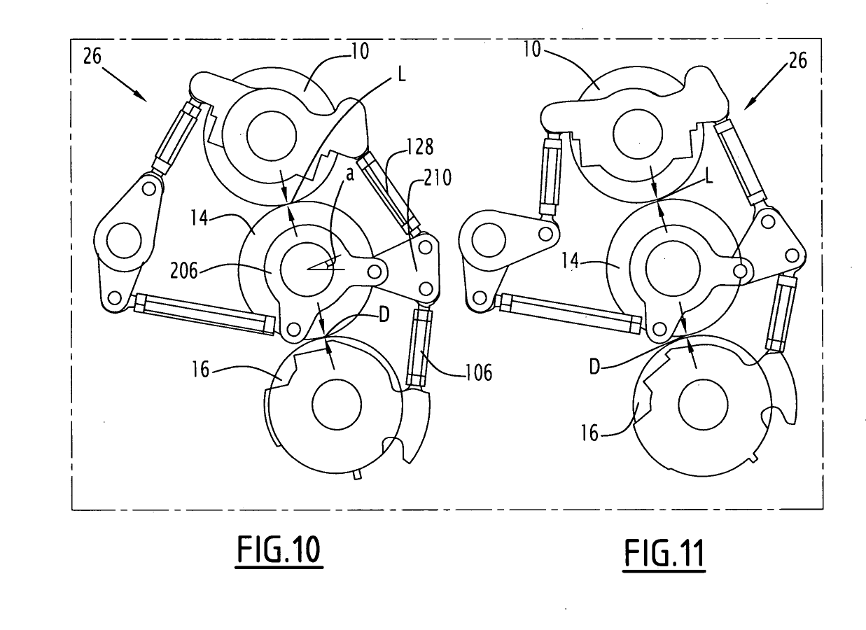

FIG. 10 again shows an operational state, but in this scenario, the operator has actuated the off center moving device 200 to adjust the distance between the two blanket cylinders 10 and 14 in “max” mode, L then being about 0.3 mm. This adjustment is adapted to optimize the printing quality on thick paper. One sees that the collar 206 of the lower blanket cylinder 14, and with it the bearing 202, have pivoted by an angle a in relation to the position shown in FIG. 8. Owing to the return triangle 210, the lower plate cylinder 16 has followed the movement of the lower blanket cylinder 14, such that the distance D is still substantially equal to 0 mm.

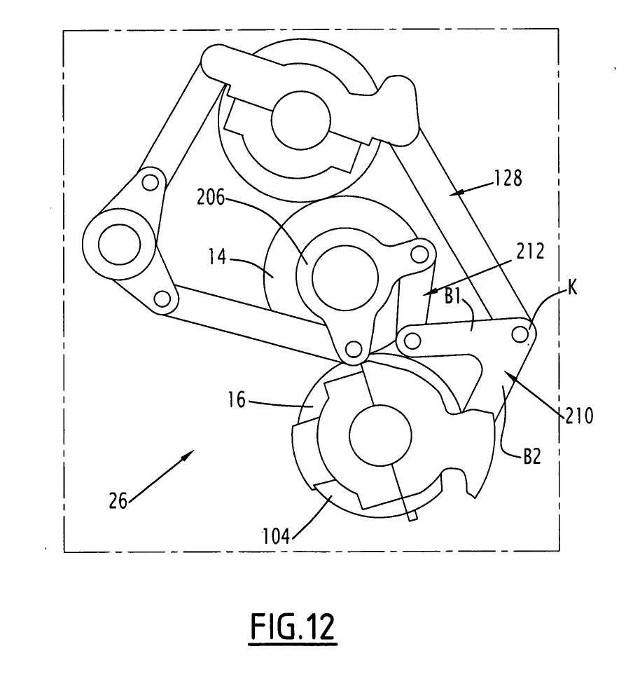

FIG. 11 corresponds to FIG. 10, the off center moving device 100 having been activated. The distance L is then equal to about 1.5 mm, while the distance D is equal to about 1.65 mm. One sees that activating the off center moving device 100, when the off center moving device 200 is in the “max” adjustment mode, results in a separation D between the lower blanket cylinder 14 and the lower plate cylinder 16 (cf. FIG. 11) that is greater than the separation D obtained during activation of the off center moving device 100 when the off center moving device 200 is in the “min” adjustment mode.

FIGS. 12 to 14 illustrate alternative embodiments of the off center moving device 200. In all three cases, they are illustrations of elements of the function side 26.

The alternative according to FIG. 12 is different from the preferred solution previously described by the shape of the return triangle 210 and the associated connecting rods. In the solution according to FIG. 12, the return triangle 210 is substantially boomerang-shaped with a bend K and two arms B1 and B2.

The arm B2 is directly connected to the collar 104 of the lower plate cylinder 16, while the arm B1 is connected to the collar 206 of the lower blanket cylinder 14 via a connecting rod 212. Thus, in relation to the preferred solution described above, the connecting rod 106 is eliminated and the connecting rod 128 is elongated.

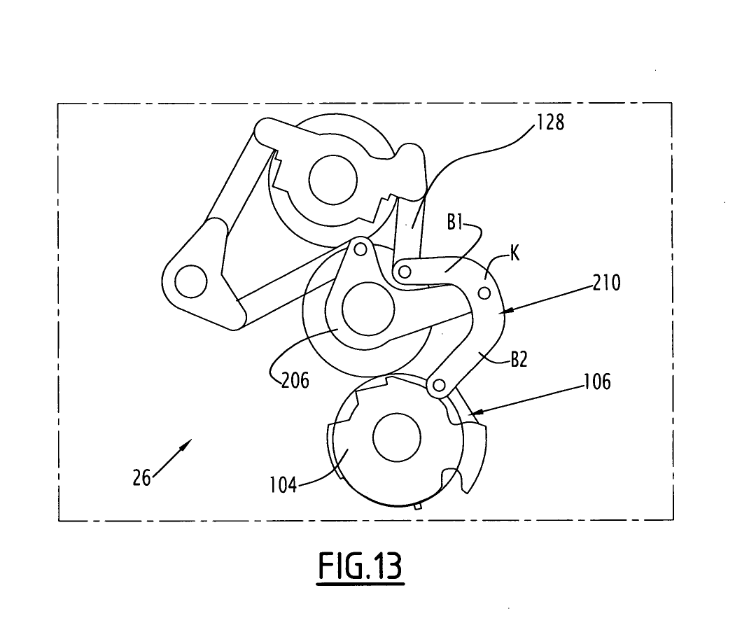

In the alternative according to FIG. 13, a boomerang-shaped return triangle 210 is also used with an apex K and two arms B1 and B2. However, the return triangle according to FIG. 13 is in the form of a continuous curve, in contrast with the return triangle according to FIG. 12, which is formed by two straight segments connected by a corner. According to FIG. 13, the arm B2 is connected to the collar 104 via the connecting rod 106. The bend K is directly connected to the collar 206.

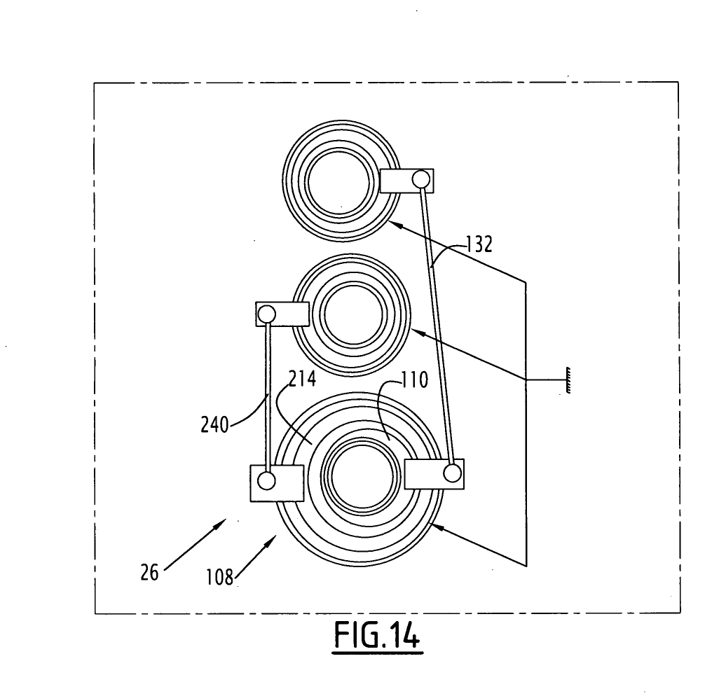

In the alternative according to FIG. 14, the three-ring eccentric bearing of the lower plate cylinder is replaced with a new four-ring eccentric bearing 108. A first ring 110 of this new bearing 108 is part of the first off center moving device 100 and is connected thereto by a connecting rod 132. A second ring 214 of this new bearing 108 is part of the second off center moving device 200 and is connected thereto by a connecting rod 240. In an embodiment that is not illustrated, the role of the rings 110 and 214 is reversed, i.e. the ring 110 is then part of the second off center moving device, while the ring 214 is part of the first off center moving device. It is this new four-ring bearing 108 that ensures the coupling between the first off center moving device 100 and the second off center moving device 200.

Comparing the preferred solution with that of FIGS. 12 to 14 shows that the preferred solution according to FIGS. 1 to 11 simultaneously enables high precision, easy adjustment, easy machining, minimal bulk, and reduced stresses and costs.

The off center moving system 5 for printing units 2 that has just been described, combining a first off center moving device 100 of the cylinders with a second device 200 for adjusting the distance between the blanket cylinders, in particular has the following advantages:

it makes it possible to adjust the distance between the blanket cylinders according to the thickness of the paper used, while preserving the contacts between the blanket cylinders and the plate cylinders before starting the printing unit;

the known function of the prior art of moving the cylinders apart when a paper break occurs is preserved;

the adjustment of the distance between the blanket cylinders is particularly easy;

it was possible to keep a maximum number of existing parts from the first off center moving device 100;

it was possible to efficiently use the empty spaces of the printing unit;

a realistic range of stresses is kept for each part; and

it was possible to preserve the adjustment of the cross-piece.

What is claimed is:

1-20. (canceled)

21. A printing unit comprising:
a frame;
a first print couple having a first blanket cylinder and a first plate cylinder;
an impression cylinder;
a first spacing device designed to move the first blanket, the first plate and the impression cylinders relative to each other between a printing configuration in which the first plate cylinder is in contact with the first blanket cylinder, and a non-printing configuration in which the first plate cylinder is moved away from the first blanket cylinder and the first blanket cylinder is moved away from the impression cylinder; and
a second spacing device designed to adjust a distance between cylindrical surfaces of the first blanket cylinder and the impression cylinder, the second spacing device moving the impression cylinder radially relative to the first blanket cylinder and relative to the frame.

22. The printing unit as recited in claim 21 further comprising a second print couple comprising a second plate cylinder and the impression cylinder, the impression cylinder being a second blanket cylinder, and in that, in the printing configuration, the second plate cylinder is in contact with the second blanket cylinder, and in the non-printing configuration, the second plate cylinder is moved away from the second blanket cylinder.

23. The printing unit as recited in claim 22 wherein the first print couple is an upper print couple and the second print couple is a lower print couple, the first plate cylinder being an upper plate cylinder and the first blanket cylinder being an upper blanket cylinder, the second blanket cylinder being a lower blanket cylinder and the second plate cylinder being a lower plate cylinder.

24. The printing unit as recited in claim 22 wherein the first spacing device is designed to move the first and second plate cylinders and the first blanket cylinder between the printing configuration and the non-printing configuration, and in that the second blanket cylinder remains immobile during that movement.

25. The printing unit as recited in claim 21 wherein the first spacing device (100) includes eccentric bearings.

26. The printing unit as recited in claim 21 wherein the second spacing device is an off center moving device and comprises:
two eccentric bearings housed in a frame, each eccentric bearing receiving one end of the impression cylinder; and
an adjusting device designed to adjust an angular position of each eccentric bearing in relation to the frame.

27. The printing unit as recited in claim 26 wherein the second spacing device comprises a transmission designed to transmit an adjustment movement, applied by the adjusting device on one of the bearings situated on one side of the frame, to the other bearing situated on another side of the frame.

28. The printing unit as recited in claim 27 wherein the first spacing device includes a shaft extending between two posts of the frame, and the transmission includes a tube surrounding said shaft.

29. The printing unit as recited in claim 22 wherein the second spacing device includes a return designed to move the second plate cylinder synchronously with the second blanket cylinder when the distance is adjusted, such that the second plate cylinder maintains contact with the second blanket cylinder in the printing configuration

30. The printing unit as recited in claim 29 wherein the return includes at least part of the first spacing device.

31. The printing unit as recited in claim 29 wherein the second spacing device includes a first collar fastened to an eccentric bearing and the return includes a member for returning a movement of the first collar to said portion of the first spacing device.

32. The printing unit as recited in claim 31 wherein the first spacing device includes a second collar associated with the second plate cylinder, and the return includes the second collar, the first collar being connected to the second collar via the return member.

33. The printing unit as recited in claim 32 wherein the return member defines a first center of rotation around which the return member turns exclusively when the first spacing device is actuated and a second center of rotation, separate from the first center of rotation, around which the return member turns exclusively when the second spacing device is adjusted.

34. The printing unit as recited in claim 32 wherein the return member is connected to the second collar by a connecting rod, and the return member is connected to the first collar by an extension of the first collar.

35. The printing unit as recited in claim 32 wherein the return member is connected to the first collar by a connecting rod, and the return member is connected to the second collar by an extension of the second collar.

36. The printing unit as recited in claim 32 wherein the return member is a return triangle that is either made up of three apices connected by straight segments, or made up of two arms connected by a bend.

37. The printing unit as recited in claim 22 wherein the second plate cylinder is associated with an eccentric bearing with four rings, a first ring of the eccentric bearing being part of the first spacing device, a second ring of the eccentric bearing being part of the second spacing device.

38. The printing unit as recited in claim 26 wherein the adjusting device comprises:
a pivoting flange connected to the eccentric bearing;
a tapping connected to the pivoting flange;
a threaded rod engaged with the tapping; and
a drive for driving the rotation of the threaded rod so as to cause the eccentric bearing to rotate.

39. The printing unit as recited in claim 21 wherein the second spacing device permits adjustment of the distance to a value exclusively between 0 and 0.3 mm.

40. A method for operating a printing unit as recited in claim 21 comprising a step for adjusting the distance between the first blanket cylinder and the impression cylinder via the second spacing device as a function of the thickness of the paper between the first blanket cylinder and the impression cylinder.
